(19) United States
(12) Patent Application Publication
(10) Pub. No.: US 2022/0229674 A1
(43) Pub. Date: Jul. 21, 2022

(54) INFORMATION PROCESSING APPARATUS, INFORMATION PROCESSING SYSTEM, AND NON-TRANSITORY COMPUTER READABLE MEDIUM FOR SUPERIMPOSING GUIDANCE USING A VIRTUAL SCREEN

(71) Applicant: FUJIFILM BUSINESS INNOVATION CORP., Tokyo (JP)

(72) Inventor: Yuki MATSUO, Kanagawa (JP)

(73) Assignee: FUJIFILM BUSINESS INNOVATION CORP., Tokyo (JP)

(21) Appl. No.: 17/369,506

(22) Filed: Jul. 7, 2021

(30) Foreign Application Priority Data
Jan. 18, 2021 (JP) 2021-005919

(51) Int. Cl. G06F 9/451; G06F 13/40; G06T 19/00

(52) U.S. Cl. CPC G06F 9/453; G06F 13/409; G06T 19/003; G06T 19/006; G06F 13/4081

(57) ABSTRACT

An information processing apparatus includes: a processor configured to: perform control that displays a virtual screen superimposed on a real space to a user; and when attaching a device to be added to an electronic substrate, display a guidance for attaching the device to the electronic substrate as the virtual screen, with respect to the electronic substrate and the device in the real space.

### CROSS-REFERENCE TO RELATED APPLICATIONS

This application is based on and claims priority under 35 USC 119 from Japanese Patent Application No. 2021-005919 filed Jan. 18, 2021.

### BACKGROUND

### (i) Technical Field

The present disclosure relates to an information processing apparatus, an information processing system, and a non-transitory computer readable medium.

### (ii) Related Art

In the related art, a device is often attached to an electronic substrate. The device can be additionally attached or detached, and can change the performance and function of an apparatus by being attached to or detached from the apparatus. Examples of such devices to be added include a memory, a storage, and a module.

JP-A-2005-157551 discloses that an RFID tag storing board information is added to an option board, and a reader/writer is provided on or near an option connector. The reader/writer reads the board information from the RFID tag so as to determine whether the option board and the option connector are electrically compatible. When the option board and the option connector are not electrically compatible, power supply to the option connector and signal drive are prevented.

### SUMMARY

In order to attach such a device on an electronic substrate, it is necessary to attach the device in a predetermined combination. For example, the device is connected to a predetermined connector provided on the electronic substrate. However, connectors for different devices often have the same shape, so that the device may be attached to a wrong position. That is, the user may attach the device to the electronic substrate in a wrong combination.

Aspects of non-limiting embodiments of the present disclosure relate to an information processing apparatus or the like that supports the user to attach a device to be added to an electronic substrate in a correct combination.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: perform control that displays a virtual screen superimposed on a real space to a user; and when attaching a device to be added to an electronic substrate, display a guidance for attaching the device to the electronic substrate as the virtual screen, with respect to the electronic substrate and the device in the real space.

### BRIEF DESCRIPTION OF THE DRAWINGS

Exemplary embodiment(s) of the present disclosure will be described in detail based on the following figures, wherein:

FIG. 1 is a diagram illustrating a terminal apparatus according to an exemplary embodiment;

FIG. 2 is a diagram illustrating a hardware configuration of the terminal apparatus;

FIG. 3 is a flowchart illustrating an operation of the terminal apparatus according to a first exemplary embodiment;

FIGS. 4A and 4B are diagrams illustrating AR screens displayed in step 104 in FIG. 3;

FIGS. 5A and 5B are diagrams illustrating AR screens displayed in step 108 in FIG. 3;

FIG. 6 is a diagram illustrating an AR screen displayed in step 112 in FIG. 3;

FIG. 7 is a diagram illustrating an AR screen displayed in step 113 in FIG. 3;

FIG. 8 is a diagram illustrating an AR screen displayed when the type of the electronic substrate cannot be specified;

FIG. 9 is a flowchart illustrating an operation of the terminal apparatus 10 according to a second exemplary embodiment;

FIG. 10 is a diagram illustrating an AR screen displayed in step 204 in FIG. 9;

FIG. 11 is a flowchart illustrating an operation of the terminal apparatus according to a third exemplary embodiment;

FIG. 12 is a diagram illustrating an AR screen displayed in step 304 in FIG. 11;

FIG. 13 is a diagram illustrating an AR screen displayed in step 306 in FIG. 11; and

FIG. 14 is a diagram illustrating an information processing system according to the present exemplary embodiment.

### DETAILED DESCRIPTION

### Configuration of Terminal Apparatus 10

Hereinafter, exemplary embodiments of the present disclosure will be described in detail with reference to accompanying drawings.

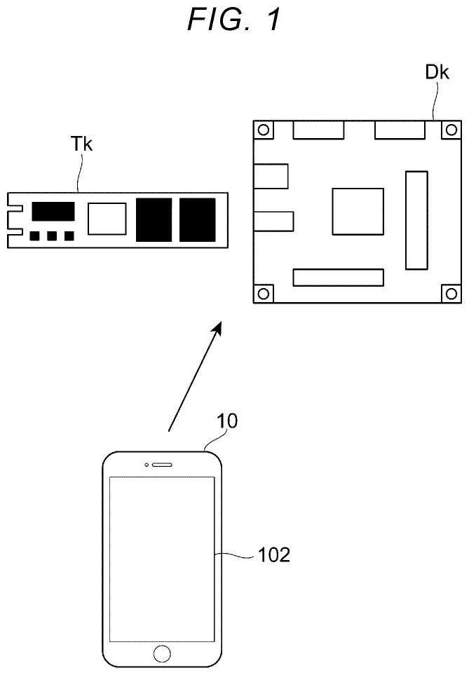

FIG. 1 is a diagram illustrating a terminal apparatus 10 according to an exemplary embodiment.

The terminal apparatus 10 is an example of an information processing apparatus. The terminal apparatus 10 is a computer apparatus such as a cell phone, a smartphone, a tablet terminal, a game machine, or a wearable terminal. The terminal apparatus 10 is configured to perform information processing and the like of the present exemplary embodiment by operating various types of application software under control of an operating system (OS).

The terminal apparatus 10 is an apparatus that uses a display 102 to display AR to the user. Here, “AR” is “augmented reality”, and refers to displaying a virtual screen superimposed on the real space to the user. The “virtual screen” is a display of an image that is created by a computer and is visually recognizable using an apparatus such as the terminal apparatus 10, and the “real space” is a space that actually exists.

As will be described in detail later, when attaching a device Tk to be added to an electronic substrate Dk, the terminal apparatus 10 displays a guidance as the virtual screen on the display 102. The “electronic substrate” is configured such that a conductor is wired on or inside a plate made of an insulator, and an electronic component is connected to the wiring by soldering or the like to operate as an electronic circuit. The electronic substrate is mounted in, for example, an apparatus such as an image forming apparatus that forms an image on a recording medium. The “device” to be added can be attached to a connector of the electronic substrate Dk, and can change the performance and function of the apparatus such as the image forming apparatus. Examples of the device Tk to be added include a memory, a storage, and a module. When the device Tk to be added is attached to the image forming apparatus, for example, the speed of forming an image is improved, or the capacity for storing images is increased. The “guidance” is a message for guiding the user to a predetermined goal. As will be described in detail later, the guidance includes, for example, the type of the electronic substrate Dk or the device Tk, and the procedure for attaching the device Tk to the electronic substrate Dk.

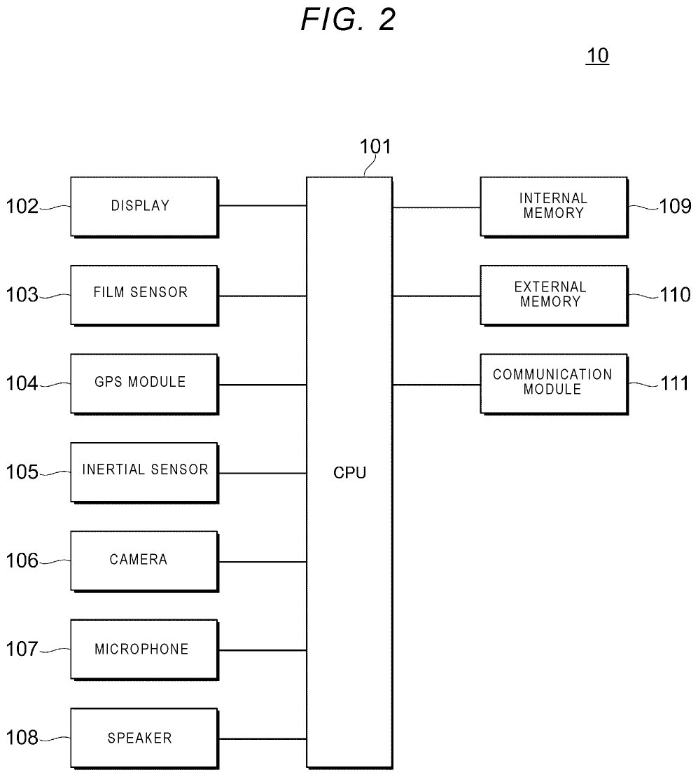

FIG. 2 is a diagram illustrating a hardware configuration of the terminal apparatus 10.

The terminal apparatus 10 illustrated in FIG. 2 includes a central processing unit (CPU) 101 that is an example of a processor and controls each unit through execution of various types of application software, the display 102 that displays images and other information, a capacitive film sensor 103 that detects an operation on a software key (hereinafter, also referred to as a “software key”) displayed on the display 102, a GPS module 104 that detects a global positioning system (GPS) signal and measures the location of the terminal apparatus 10, an inertial sensor 105, a camera 106, a microphone 107 used for calling and audio recording, a speaker 108 used for outputting audio, an internal memory 109 storing data and internal data, an external memory 110 as an auxiliary storage device, and a communication module 111 used for communication with an external apparatus.

In the present exemplary embodiment, the internal memory 109 and the external memory 110 are semiconductor memories. The internal memory 109 includes a read only memory (ROM) in which a basic input output system (BIOS) or the like is stored, and a random access memory (RAM) serving as a main memory. The CPU 101 and the internal memory 109 constitute a computer. The CPU 101 uses the RAM as a work space for the program. The external memory 110 stores firmware and application software.

The display 102 is an example of a display that displays a virtual screen superimposed on the real space to the user. The display 102 includes, for example, an organic electro luminescent (EL) display or a liquid crystal display. The display 102 in the present exemplary embodiment is formed on a single substrate. In the present exemplary embodiment, an image and other information are displayed on a surface (that is, a display surface) of the display 102. The image here includes an image captured by the camera 106 (hereinafter, also referred to as a “captured image”). The display 102 in the present exemplary embodiment is not bendable or foldable.

The film sensor 103 is disposed on the surface of the display 102. The film sensor 103 has a characteristic of not interfering with viewing of information displayed on the display 102, and detects a location operated by the user based on a change in capacitance.

The GPS module 104 is used to measure the location of the terminal apparatus 10. A sensor technique other than the GPS module 104 may be used to measure the location of the terminal apparatus 10. For example, the location may be measured by receiving a Bluetooth (registered trademark) signal or a Wi-Fi signal from a beacon.

The inertial sensor 105 is, for example, a six-axis sensor that detects acceleration and angular velocity. The inertial sensor 105 can detect the posture of the terminal apparatus 10. In addition, the terminal apparatus 10 may be provided with a geomagnetic sensor. The imaging direction may be specified by using the geomagnetic sensor.

The camera 106 is, for example, a complementary metal oxide semiconductor (CMOS) image sensor or a charge-coupled device (CCD) image sensor. In the present exemplary embodiment, the camera 106 is attached as an integral unit to the terminal apparatus 10. There may be plural cameras 106. The camera 106 is an example of an imaging device.

The microphone 107 is a device that converts the voice of the user or ambient sound into an electric signal. In the present exemplary embodiment, the microphone 107 is also used to input an instruction by the voice of the user. For example, the microphone 107 is used to input an instruction indicating the number of areas used for displaying the AR content and the type of the AR content to be displayed in each area.

The speaker 108 is a device that converts the electric signal into a sound and outputs the sound.

The communication module 111 includes a module for a mobile communication system and a module for a wireless LAN.

### Detailed Description of Terminal Apparatus 10

### First Exemplary Embodiment

Next, the terminal apparatus 10 will be described in detail.

First, a first exemplary embodiment of the terminal apparatus 10 will be described. In the first exemplary embodiment, when attaching the device Tk to be added to the electronic substrate Dk, the terminal apparatus 10 displays a guidance for attaching the device Tk to be added to the electronic substrate Dk as a virtual screen, with respect to the electronic substrate Dk and the device Tk to be added in the real space. Then, the terminal apparatus 10 determines the guidance based on the image obtained by imaging the electronic substrate Dk and the image obtained by imaging the device Tk to be added.

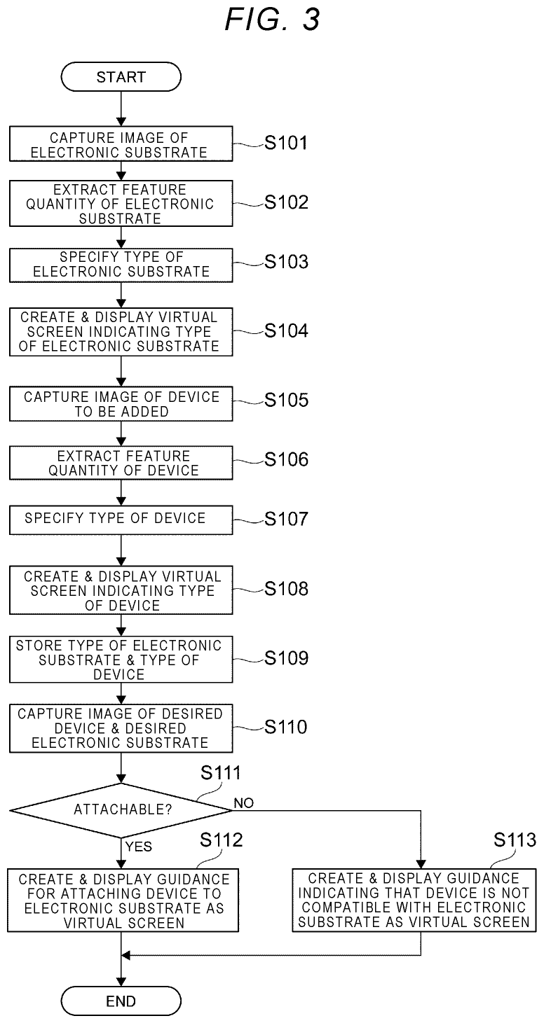

FIG. 3 is a flowchart illustrating an operation of the terminal apparatus 10 according to the first exemplary embodiment.

First, the user captures an image of the electronic substrate Dk, using the camera 106 (step 101).

Then, the CPU 101 extracts a feature quantity of the electronic substrate Dk based on the captured image of the electronic substrate Dk (step 102). The feature quantity indicates a part that is included in the captured electronic substrate Dk and is different from other electronic substrates. The feature quantity indicates, for example, the shape and location of each of a component, a connector, an attachment screw, and a screw hole of the electronic substrate Dk.

Further, the CPU 101 specifies the type of the electronic substrate Dk based on the extracted feature quantity (step 103). The type of the electronic substrate Dk can be specified by comparing the extracted feature quantity with the feature quantity stored in advance in the external memory 110 and determining whether the extracted feature quantity matches the feature quantity stored in advance.

Then, the CPU 101 creates the virtual screen indicating the type of the electronic substrate Dk, and displays the virtual screen as an AR screen on the display 102 (step 104).

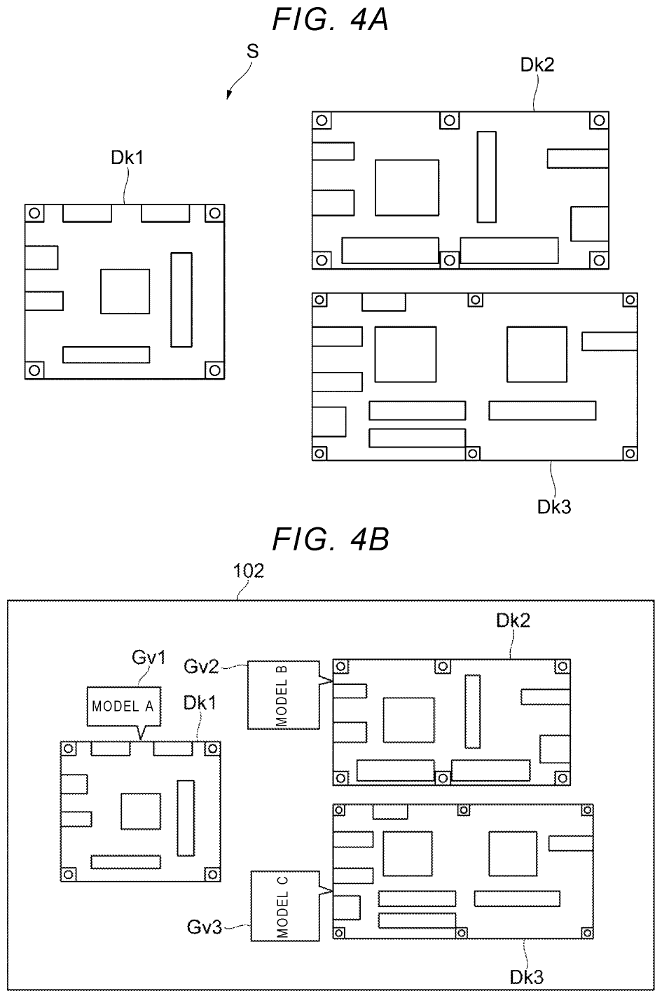

FIGS. 4A and 4B are diagrams illustrating AR screens displayed in step 104 in FIG. 3.

Herein, FIG. 4A illustrates a real space S. In this case, the electronic substrates Dk1 to Dk3 exist in the real space S. On the other hand, FIG. 4B illustrates an AR screen on the display 102 displaying a virtual screen superimposed on the real space S. In this case, first, images of the electronic substrates Dk1 to Dk3 in the real space S are displayed on the display 102. In addition, “model A”, “model B”, and “model C” are displayed as virtual screens Gv1 to Gv3, with respect to the electronic substrates Dk1 to Dk3, respectively. The virtual screen is an example of guidance indicating information on the type of the electronic substrate Dk obtained from images obtained by imaging the electronic substrates Dk.

Returning to FIG. 3, the user captures an image of the device Tk to be added, using the camera 106 (step 105).

Then, the CPU 101 extracts the feature quantity of the device Tk to be added, based on the captured image of the device Tk (step 106). The “feature quantity” indicates a part that is included in the device Tk to be added, and is different from other devices. The feature quantity indicates, for example, the shape and location of each of a component, a connector, an attachment screw, and a screw hole of the device Tk.

Further, the CPU 101 specifies the type of the device Tk to be added, based on the extracted feature quantity (step 107). The type of the device Tk to be added can be specified by comparing the extracted feature quantity with the feature quantity stored in advance in the external memory 110 and determining whether the extracted feature quantity matches the feature quantity stored in advance.

Then, the CPU 101 creates the virtual screen indicating the type of the device Tk, and displays the virtual screen as an AR screen on the display 102 (step 108).

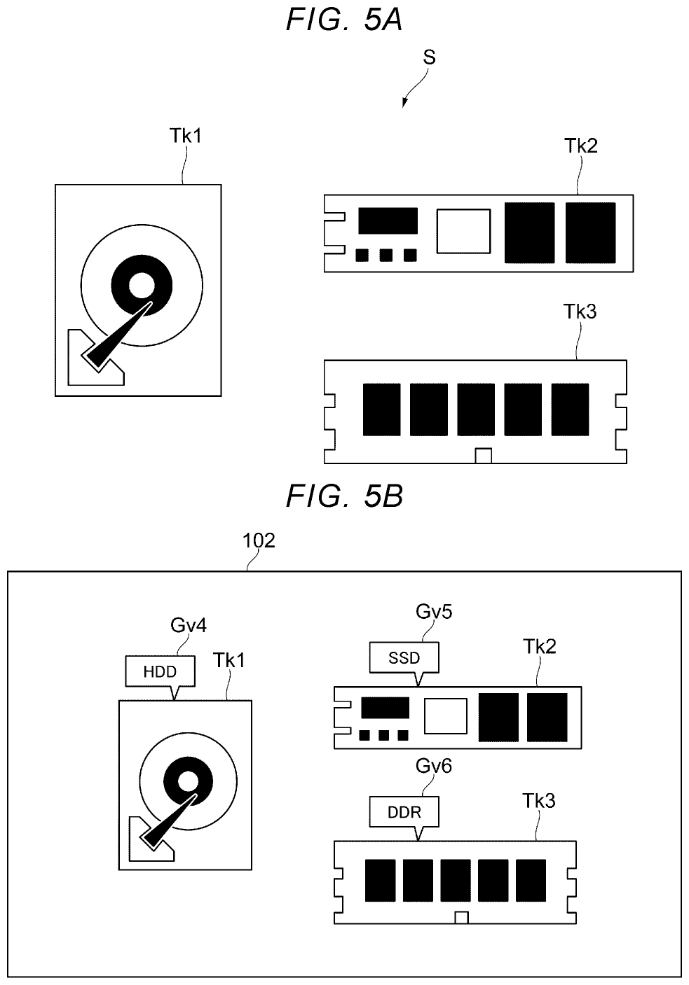

FIGS. 5A and 5B are diagrams illustrating AR screens displayed in step 108 in FIG. 3.

Herein, FIG. 5A illustrates the real space S. In this case, the devices Tk1 to Tk3 exist in the real space S. On the other hand, FIG. 5B illustrates an AR screen on the display 102 displaying a virtual screen superimposed on the real space S. In this case, first, a virtual screen of the real space S is displayed on the display 102. In addition, “HDD”, “SSD”, and “DDR” are displayed as virtual screens Gv4 to Gv6, with respect to the devices Tk1 to Tk3, respectively. The virtual screen is an example of guidance indicating information on the type of the device Tk obtained from images obtained by imaging the device.

Any of steps 101 to 104 and steps 105 to 108 may be performed first. That is, steps 105 to 108 may be performed first, and steps 101 to 104 may be performed later.

Returning to FIG. 3 again, the CPU 101 stores the type of the electronic substrate Dk specified in step 103 and the type of the device Tk specified in step 107 in the external memory 110 (step 109).

Further, the user captures an image of both the device Tk desired to be used and the electronic substrate Dk to which the device Tk is desired to be attached, using the camera 106 (step 110).

Then, the CPU 101 determines whether the device Tk can be attached to the electronic substrate Dk (step 111).

As a result, when the device Tk can be attached (Yes in step 111), the CPU 101 creates the guidance for attaching the device Tk to the electronic substrate Dk as the virtual screen and displays the virtual screen as the AR screen on the display 102 (step 112).

On the other hand, when the device Tk cannot be attached (No in step 111), the CPU 101 creates the guidance indicating that the device Tk is not compatible with the electronic substrate Dk as the virtual screen and displays the virtual screen as the AR screen on the display 102 (step 113).

That is, in steps 112 and 113, the CPU 101 displays information on the compatibility between the electronic substrate Dk and the device Tk obtained from the information on the types of the electronic substrate Dk and the device Tk, as the guidance. Here, “compatibility” refers to whether the device Tk to be added can be attached to the electronic substrate Dk. When the device Tk can be attached, the compatibility is confirmed, and when the device Tk cannot be attached, the compatibility is not confirmed. Then, the guidance displayed in step 112 is information on the procedure for attaching the device Tk to the electronic substrate Dk when the compatibility is confirmed. On the other hand, the guidance displayed in step 113 is information indicating that the device Tk cannot be attached to the electronic substrate Dk when the compatibility is not confirmed.

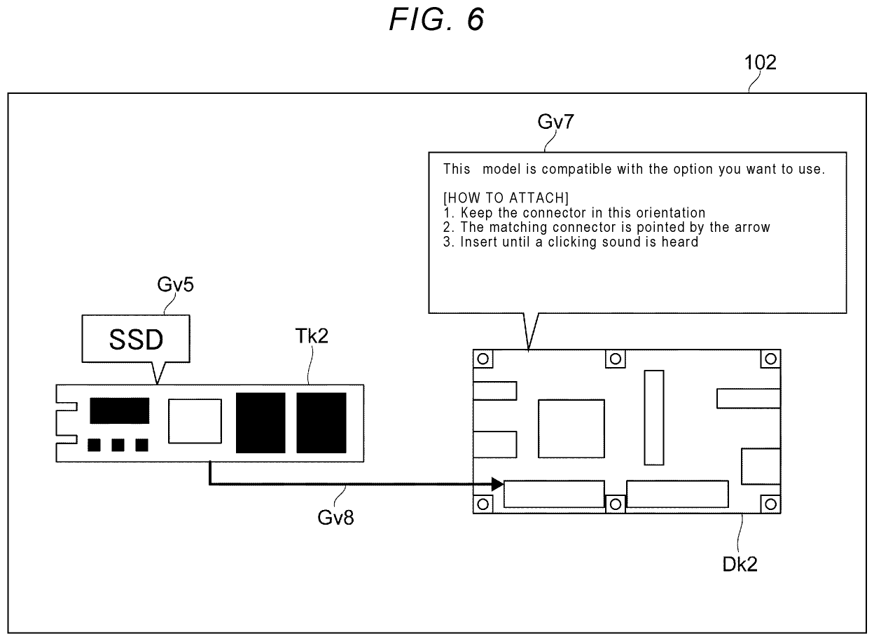

FIG. 6 is a diagram illustrating an AR screen displayed in step 112 in FIG. 3.

Here, the guidance of “SSD” is displayed as the virtual screen Gv5, with respect to the device Tk2. A message “This model is compatible with the option you want to use.” as a guidance indicating that the device Tk2 can be attached to the electronic substrate Dk2 and the procedure for attaching the device Tk2 to the electronic substrate Dk2 described in step 112 are displayed as a virtual screen Gv7. When the electronic substrate Dk2 includes plural connectors, a guidance indicating the connector to which the device Tk2 is to be attached is displayed as a virtual screen Gv8. In this case, the virtual screen Gv8 is an arrow pointing in a direction from the device Tk2 to a compatible connector.

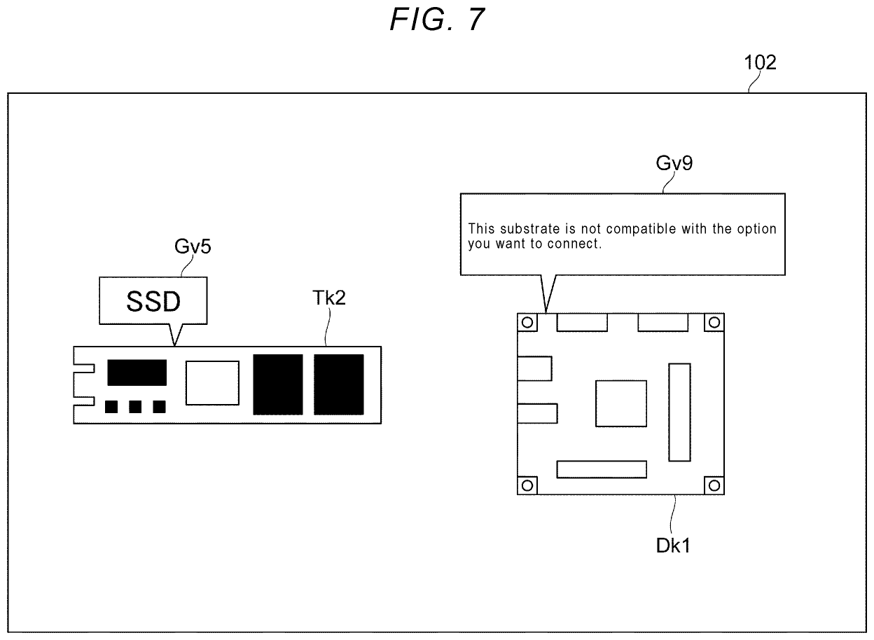

FIG. 7 is a diagram illustrating an AR screen displayed in step 113 in FIG. 3.

Here, the guidance of “SSD” is displayed as the virtual screen Gv5, with respect to the device Tk2. At the same time, a message “This substrate is not compatible with the option you want to connect.” as a guidance indicating that the device Tk2 cannot be attached to the electronic substrate Dk1 described in step 113 is displayed as a virtual screen Gv9.

As the above-described guidance, the CPU 101 can also display information indicating a candidate of the type when the type of the electronic substrate Dk or the device Tk cannot be specified in step 103 or step 107 in FIG. 3.

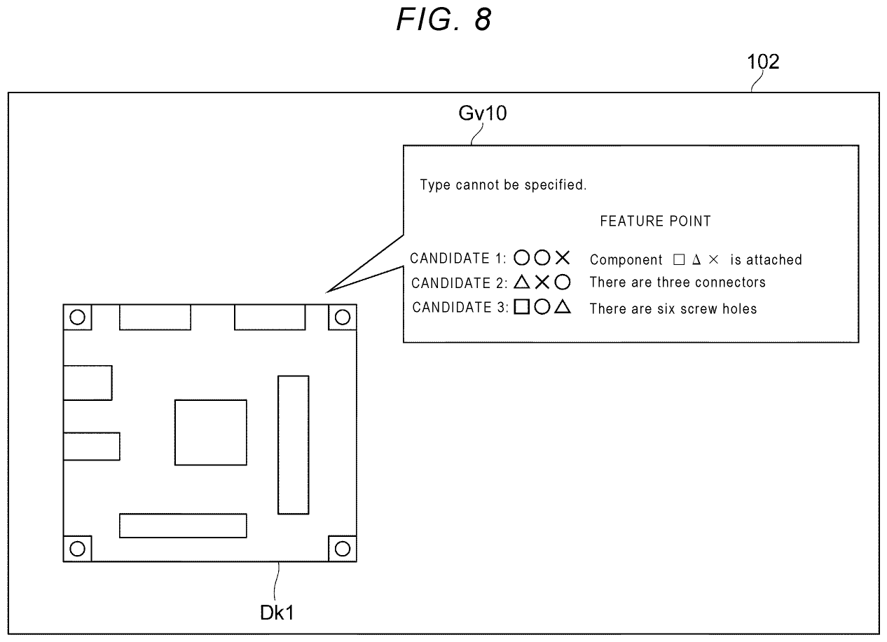

FIG. 8 is a diagram illustrating an AR screen displayed when the type of the electronic substrate Dk1 cannot be specified.

Here, a virtual screen Gv10 is displayed. On the virtual screen Gv10, “Candidate 1: ∘∘x”, “Candidate 2: Δx∘”, and “Candidate 3: □◯Δ” are displayed as the candidates of the type together with the guidance of “Type cannot be specified”. Then, the user select one of the candidates by touching the display 102 or the like, and thus can specify the type.

The virtual screen Gv10 further includes information on a feature point of the candidates. Here, as the feature point, “Component □Δx is attached” is displayed for candidate 1. Similarly, “There are three connectors” is displayed for the candidate 2, and “There are six screw holes” is displayed for the candidate 3. Displaying the feature points together with the candidates helps the user to make a selection and makes it easier to specify the type. Here, information on only one feature point is displayed. However, information on plural feature points may be displayed.

### Second Exemplary Embodiment

Next, the second exemplary embodiment of the terminal apparatus 10 will be described. In the second exemplary embodiment, when the device Tk is detached from the electronic substrate Dk, the terminal apparatus 10 displays a detachment guidance as a virtual screen.

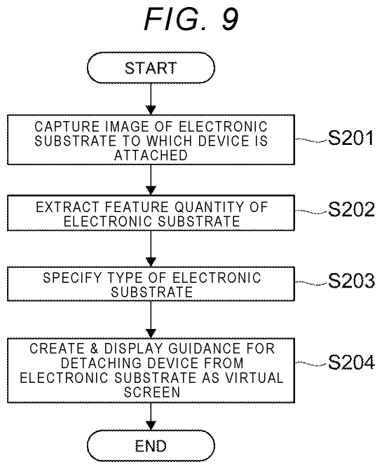

FIG. 9 is a flowchart illustrating an operation of the terminal apparatus 10 according to the second exemplary embodiment.

First, the user captures an image of the electronic substrate Dk to which the device Tk is attached, using the camera 106 (step 201).

Then, the CPU 101 extracts the feature quantity of the electronic substrate Dk, based on the captured image of the electronic substrate Dk (step 202).

Further, the CPU 101 specifies the type of the electronic substrate Dk, based on the extracted feature quantity (step 203). The type of the electronic substrate Dk can be specified by comparing the extracted feature quantity with the feature quantity stored in advance in the external memory 110 and determining whether the extracted feature quantity matches the feature quantity stored in advance.

Then, based on the specified type of the electronic substrate Dk, the CPU 101 creates a guidance for detaching the device Tk from the electronic substrate Dk as the virtual screen, and displays the virtual screen as the AR screen on the display 102 (step 204).

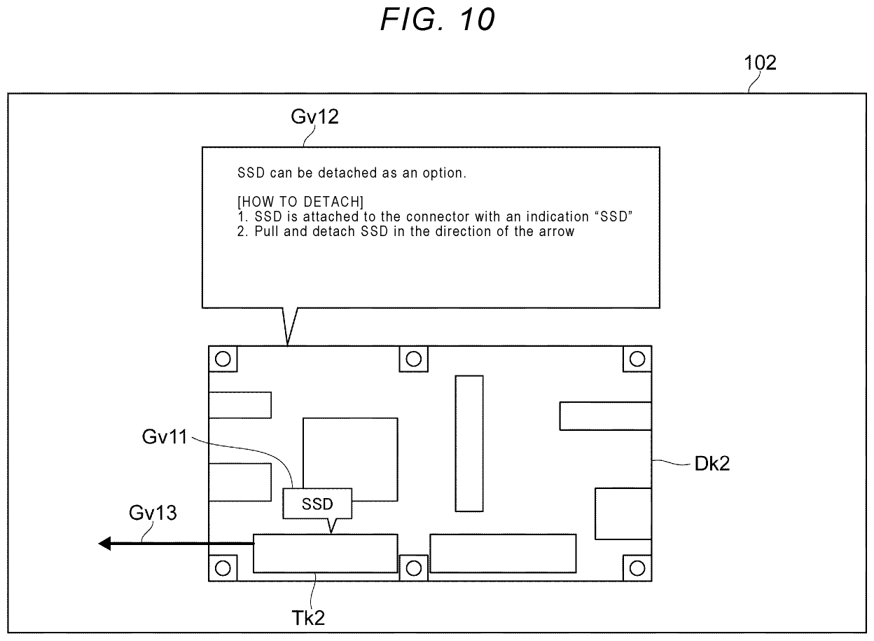

FIG. 10 is a diagram illustrating the AR screen displayed in step 204 in FIG. 9.

Here, the guidance of “SSD” is displayed as a virtual screen Gv11, with respect to the device Tk2. A guidance “SSD can be detached as an option.” as a guidance for detaching the device Tk2 from the electronic substrate Dk2 and the procedure for detaching the device Tk2 from the electronic substrate Dk2 described in step 204 are displayed as a virtual screen Gv12. When the electronic substrate Dk2 includes plural connectors, a guidance indicating from which connector the device is to be detached is displayed as a virtual screen Gv13. In this case, the virtual screen Gv13 is an arrow pointing outward from the connector to which the device Tk2 is attached. When plural devices are attached to the same electronic substrate, plural guidance for detaching respective devices may be displayed.

### Third Exemplary Embodiment

Next, the third exemplary embodiment of the terminal apparatus 10 will be described. In the third exemplary embodiment, information indicating the location of the electronic substrate Dk or the location of the device Tk, which is a location not visually recognizable by the user, is displayed as the guidance when providing the detachment guidance.

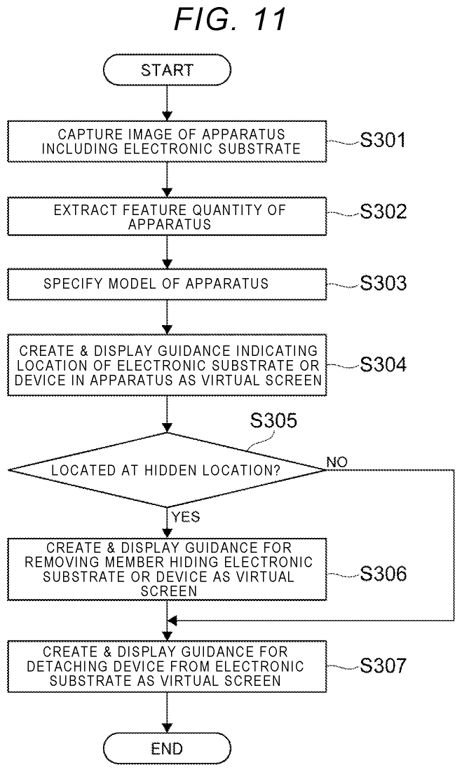

FIG. 11 is a flowchart illustrating an operation of the terminal apparatus 10 according to the third exemplary embodiment.

First, the user captures an image of an apparatus including the electronic substrate Dk, using the camera 106 (step 301). When the apparatus is the image forming apparatus, for example, the entire image forming apparatus is imaged. A plate or the like on which a manufacturer, a model number, or the like is described may be imaged.

Then, the CPU 101 extracts a feature quantity of the apparatus, based on the image obtained by imaging the apparatus (step 302). In the case where the entire apparatus is imaged, the feature quantity is the shape, the color, or the like of the apparatus. In the case where a plate on which a manufacturer, a model number, or the like is described is imaged, the feature quantity is the content described.

Further, the CPU 101 specifies the model of the apparatus, based on the extracted feature quantity (step 303). The model of the apparatus can be specified by comparing the extracted feature quantity with the feature quantity stored in advance in the external memory 110 and determining whether the extracted feature quantity matches the feature quantity stored in advance.

Then, the CPU 101 creates a guidance indicating the location of the electronic substrate Dk or the device Tk in the apparatus as a virtual screen based on the specified model of the apparatus, and displays the guidance as the AR screen on the display 102 (step 304).

Next, the CPU 101 determines whether the electronic substrate Dk or the device Tk is located at a location hidden from the user (step 305). The electronic substrate Dk or the device Tk is located at a location hidden from the user when hidden by a cover, for example. Whether the electronic substrate Dk or the device Tk is located at the hidden location can be determined based on the specified model of the apparatus.

As a result, if the electronic substrate Dk or the device Tk is not at the hidden location (No in step 305), the processing proceeds to step 307.

On the other hand, when the electronic substrate Dk or the device Tk is in the hidden location (Yes in step 305), a guidance for removing a member such as a cover hiding the electronic substrate Dk or the device Tk is created as a virtual screen, and displayed on the display 102 as the AR screen (step 306).

Then, based on the specified model of the apparatus, the CPU 101 creates a guidance for detaching the device Tk from the electronic substrate Dk as a virtual screen, and displays the virtual screen as the AR screen on the display 102 (step 307).

That is, the detachment guidance is determined from an image obtained by imaging an apparatus including the electronic substrate Dk and the device Tk. That is, in step 301, an image of an apparatus including the electronic substrate Dk and the device Tk is imaged. Then, in step 303 and step 307, the CPU 101 determines the detachment guidance based on the captured image.

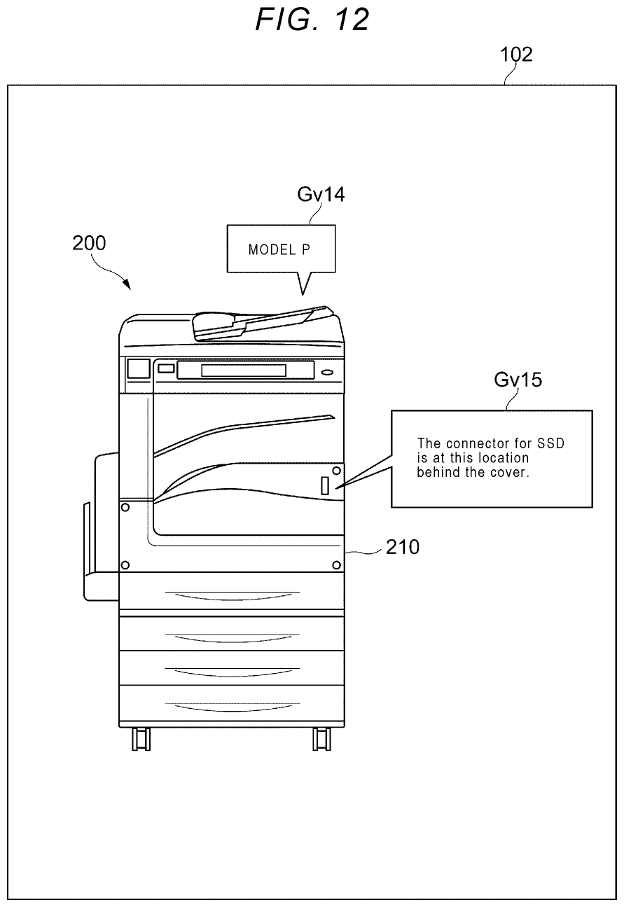

FIG. 12 is a diagram illustrating the AR screen displayed in step 304 in FIG. 11.

On the AR screen illustrated in the diagram, a guidance of “model P”, which is information of the model, is displayed as a virtual screen Gv14, with respect to the image forming apparatus 200 as the apparatus including the electronic substrate Dk.

Here, as a guidance indicating the location of the electronic substrate Dk or the device Tk in the apparatus, a guidance indicating the location of the SSD as the device Tk in the image forming apparatus 200 is displayed as a virtual screen Gv15. Specifically, a guidance “The connector for SSD is at this location behind the cover.” is displayed as the virtual screen Gv15. In this case, the SSD is hidden by a cover 210. Therefore, the guidance can be considered as information indicating the location of the electronic substrate Dk or the location at which the device Tk is attached to the electronic substrate Dk, which is a location not visually recognizable by the user.

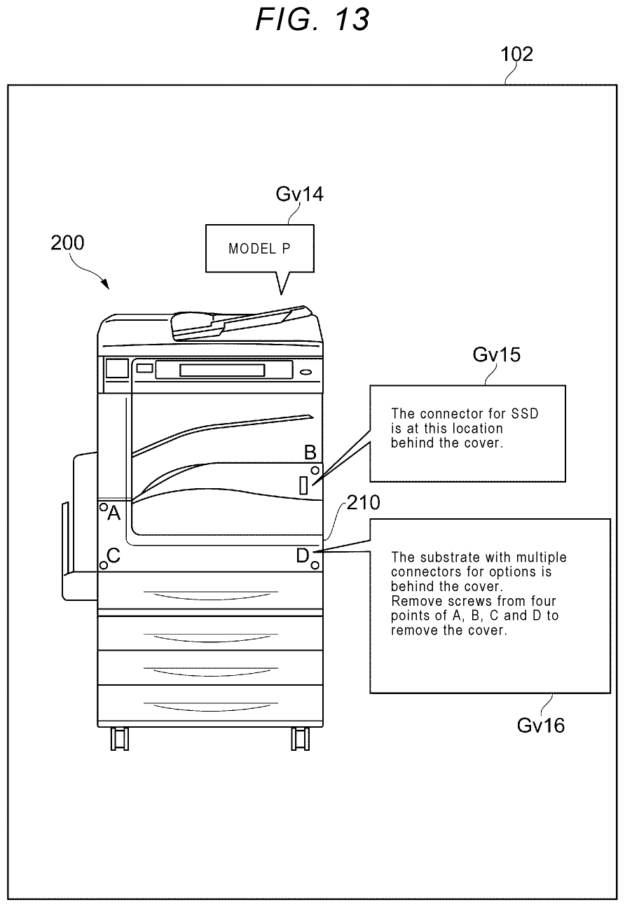

FIG. 13 is a diagram illustrating the AR screen displayed in step 306 in FIG. 11.

The illustrated AR screen further displays a virtual screen Gv16 in addition to the virtual screens Gv14 and Gv15 illustrated in FIG. 12.

That is, since there is an SSD behind the cover 210 of the image forming apparatus 200, guidance for removing the cover 210 hiding the SSD is displayed as the virtual screen Gv16. Specifically, in addition to the display of each of A, B, C, and D, a guidance of “The substrate with multiple connectors for options is behind the cover. Remove screws from four points of A, B, C and D to remove the cover.” is displayed.

The guidance can be considered as information on the procedure for allowing the user to visually recognize the location that has not been visually recognizable. That is, when the electronic substrate Dk is behind the cover 210, the user cannot visually recognize the electronic substrate Dk. Thus, the guidance for removing the cover 210 can be regarded as information on the procedure for allowing the user to visually recognize the electronic substrate Dk that has not been visually recognizable.

The AR screen displayed in step 307 is, for example, the same as that in FIG. 10.

The guidance described in FIGS. 12 and 13 may be displayed when attaching the device Tk to the electronic substrate Dk in the first exemplary embodiment. That is, when attaching the device Tk to the electronic substrate Dk, if the electronic substrate Dk is at a location hidden by a member such as the cover 210, a guidance indicating the location of the electronic substrate Dk in the apparatus can be displayed. The guidance for removing a member such as the cover 210 can also be displayed as a virtual screen.

Referring to the image forming apparatus 200 as the apparatus, in recent years, in order to improve a development efficiency and reduce the production cost of the image forming apparatus 200, standardization of substrates has progressed. Therefore, even substrates of different models have a similar appearance. In the related art, the electronic substrate Dk often includes plural connectors for devices Tk such as options for function expansion. In general, plural connectors for options have different shapes such that the options can be connected to the correct connectors. However, in recent years, since it is costly to prepare different connectors, it is increasingly common to employ plural connectors having the same shape. Not only a maintenance operator, but also a general user may connect the options. Thus, since the electronic substrates Dk of different models have a similar appearance, the electronic substrates Dk are likely to be erroneously recognized. Also, since connectors having the same shape are employed as the connectors for the options or since there are a large number of connectors, the options may be connected to wrong connectors. The electronic substrate Dk may be at a location hidden by the cover 210 or the like. Further, when there are a large number of accessories, it may be difficult to determine which accessory is compatible.

According to the exemplary embodiment described in detail above, the AR screen described above is displayed on the terminal apparatus 10 so as to support the user to attach the device Tk to be added to the electronic substrate Dk in a correct combination. Even when the electronic substrate Dk includes plural connectors having the same shape, it is possible to display a guidance for attaching the device Tk to a compatible connector, and the user can attach the device Tk to a correct connector.

When detaching the added device Tk from the electronic substrate Dk, it is possible to indicate the location of the device Tk and the method of detaching the device Tk.

Further, in the apparatus such as the image forming apparatus 200, even when the electronic substrate Dk or the device Tk is at the location hidden by the cover 210 or the like, it is possible to indicate the location. Then, it is possible to indicate a method of removing a member such as the cover 210 that hides the electronic substrate Dk or the device Tk.

Although in the terminal apparatus 10 described above, the imaging of the device Tk and the electronic substrate Dk and the creation and display of the virtual screen are performed by the terminal apparatus 10, the present disclosure is not limited thereto.

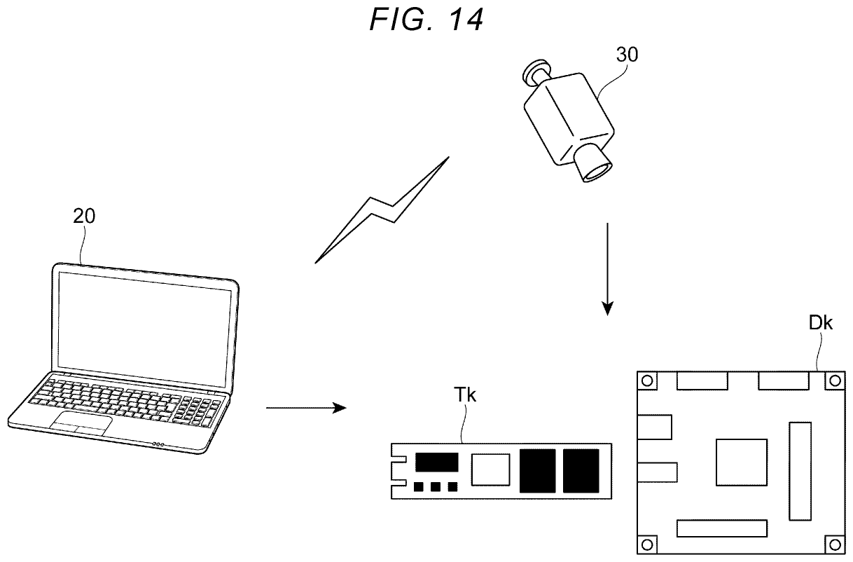

FIG. 14 is a diagram illustrating an information processing system 1 according to the present exemplary embodiment.

The illustrated information processing system 1 includes a terminal apparatus 20 and a camera 30.

In information processing system 1 according to the present exemplary embodiment, the terminal apparatus 20 and the camera 30 are paired. Pairing is performed by wireless connection such as Bluetooth (registered trademark), for example. However, the connection is not limited thereto, and may be established via a wireless local area network (LAN), the Internet, or the like. Furthermore, the connection is not limited to the wireless connection, and may be wired connection via digital visual interface (DVI), high-definition multimedia interface (registered trademark) (HDMI), DisplayPort, universal serial bus (USB), IEEE1394, RS-232C, or the like.

The terminal apparatus 20 is, for example, a computer apparatus such as a personal computer (PC), a cell phone, a smartphone, or a tablet.

The camera 30 includes, for example, an optical system that converges incident light and an image sensor that detects the light converged by the optical system.

The optical system includes a single lens or a combination of plural lenses. In the optical system, various aberrations are removed by a combination of lenses, a coating applied to the lens surface, and the like. The image sensor includes imaging elements such as charge coupled devices (CCDs) or complementary metal oxide semiconductors (CMOSs) arranged therein.

The camera 30 captures an image of the electronic substrate Dk, the device Tk, and the apparatus such as the image forming apparatus 200. Then, the captured image is transmitted to the terminal apparatus 20 by a communication unit such as Bluetooth. Then, the terminal apparatus 20 creates a virtual screen based on the image created by the camera 30, and displays the AR screen.

That is, in the information processing system 1, the camera 30 captures images of the electronic substrate Dk, the device Tk, and the apparatus such as the image forming apparatus 200, and the terminal apparatus 20 creates the virtual screen, and displays the AR screen.

As another form, the virtual screen may be created by a cloud server apparatus disposed on the cloud, and may be displayed on the terminal apparatus 10 or the terminal apparatus 20 described above.

Furthermore, a smart glass, an AR glass, a head-mounted display, or the like may be used in place of the terminal apparatus 10 or the terminal apparatus 20.

### Description of Program

Here, processing performed by the terminal apparatus 10 or the terminal apparatus 20 in the present exemplary embodiment described above is implemented by a program such as application software.

Therefore, the program for implementing the processing performed by the terminal apparatus 10 or the terminal apparatus 20 according to the present exemplary embodiment can be regarded as a program causing a computer to execute information processing, the information processing including: performing control that displays the virtual screen superimposed on the real space S to the user; and when attaching the device Tk to be added to the electronic substrate Dk, displaying a guidance for attaching the device Tk to the electronic substrate Dk as the virtual screen, with respect to the electronic substrate Dk and the device Tk in the real space S.

The program implementing the present exemplary embodiment may be provided by a communication unit, or may be provided by being stored in a recording medium such as a CD-ROM.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Although the present exemplary embodiments are described above, the technical scope of the present disclosure is not limited to the above exemplary embodiments. It is obvious from the description of the scope of claims that various modifications and improvements of the above exemplary embodiments are also included in the technical scope of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
a processor configured to:
perform control that displays a virtual screen superimposed on a real space to a user;
when attaching a device to be added to an electronic substrate, display a guidance for attaching the device to the electronic substrate as the virtual screen, with respect to the electronic substrate and the device in the real space; and
determine the guidance based on an image obtained by imaging the electronic substrate and an image obtained by imaging the device, wherein
the guidance includes information on a type of the electronic substrate obtained from the image obtained by imaging the electronic substrate, and information on a type of the device obtained from the image obtained by imaging the device, and
the guidance includes information indicating a candidate of the type of the electronic substrate or the type of the device and information of one or more visually identifiable features of the candidate when the type of the electronic substrate or the type of the device is unspecified.

2. (canceled)

3. (canceled)

4. The information processing apparatus according to claim 1, wherein the guidance is information on compatibility between the electronic substrate and the device obtained from the information on the type of the electronic substrate and on the type of the device.

5. The information processing apparatus according to claim 4, wherein the guidance is information on a procedure for attaching the device to the electronic substrate when the compatibility is confirmed.

6. The information processing apparatus according to claim 1, wherein the processor is configured to:
determine the type of the electronic substrate based on a feature quantity of the electronic substrate, and determine the type of the device based on a feature quantity of the device.

7. The information processing apparatus according to claim 6, wherein the feature quantity is a shape and/or a location of at least one of a component, a connector, an attachment screw, or a screw hole of the electronic substrate and the device.

8. (canceled)

9. (canceled)

10. The information processing apparatus according to claim 1, wherein the processor is configured to:
further display a detachment guidance as the virtual screen when detaching the device from the electronic substrate.

11. The information processing apparatus according to claim 10, wherein the detachment guidance is determined from an image obtained by imaging an apparatus including the electronic substrate and the device.

12. The information processing apparatus according to claim 1, wherein the guidance is information indicating a location not visually recognizable by a user and indicating a location of the electronic substrate and/or a location at which the device is attached to the electronic substrate.

13. The information processing apparatus according to claim 12, wherein the guidance is information on a procedure for allowing the user to visually recognize the location that has not been visually recognizable.

14. An information processing system comprising:
a display configured to display a virtual screen superimposed on a real space to a user; and
a processor configured to:
when attaching a device to be added to an electronic substrate, display a guidance for attaching the device to the electronic substrate as the virtual screen on the display, with respect to the electronic substrate and the device in the real space; and
determine the guidance based on an image obtained by imaging the electronic substrate and an image obtained by imaging the device, wherein
the guidance includes information on a type of the electronic substrate obtained from the image obtained by imaging the electronic substrate, and information on a type of the device obtained from the image obtained by imaging the device, and
the guidance includes information indicating a candidate of the type of the electronic substrate or the type of the device and information of one or more visually identifiable features of the candidate when the type of the electronic substrate or the type of the device is unspecified.

15. A non-transitory computer readable medium storing a program causing a computer to execute information processing, the information processing comprising:
performing control that displays a virtual screen superimposed on a real space to a user;
when attaching a device to be added to an electronic substrate, displaying a guidance for attaching the device to the electronic substrate as the virtual screen, with respect to the electronic substrate and the device in the real space; and
determining the guidance based on an image obtained by imaging the electronic substrate and an image obtained by imaging the device, wherein
the guidance includes information on a type of the electronic substrate obtained from the image obtained by imaging the electronic substrate, and information on a type of the device obtained from the image obtained by imaging the device; and
the guidance includes information indicating a candidate of the type of the electronic substrate or the type of the device and information of one or more visually identifiable features of the candidate when the type of the electronic substrate or the type of the device is unspecified.
